(19) United States
(12) Patent Application Publication
(10) Pub. No.: US 2017/0049063 A1
(43) Pub. Date: Feb. 23, 2017

(54) HYDROCULTURE MEDIA AND METHOD OF USING SAME

(71) Applicant: Southeast Nonwovens, Inc., Clover, SC (US)

(72) Inventor: Steven F. Nielsen, Charlotte, NC (US)

(21) Appl. No.: 15/147,038

(22) Filed: May 5, 2016

Related U.S. Application Data
(60) Provisional application No. 62/205,815, filed on Aug. 17, 2015.
(60) Provisional application No. 62/205,831, filed on Aug. 17, 2015.

(51) Int. Cl. A01G 31/00; A01G 1/00

(52) U.S. Cl. CPC A01G 31/001; A01G 1/001

(57) ABSTRACT

Hydroculture media can be a synthetic soil including a three dimensional solid made of a plurality of fibers. The three dimensional solids can be a variety of shapes, such as spheres, cylinders, cones, cubes, cuboids, parallelepipeds, polyhedrons (e.g., pyramid, tetrahedron, octahedron, dodecahedron, icosahedron), prisms, spheroids, ellipsoids, paraboloids, hyperboloids, rings, and combinations thereof. The solids can have a length/diameter ratio in the range of 0.1-5:1. Some or all of the fibers can include an antimicrobial substance and/or plant nutrients.

### CROSS REFERENCE TO RELATED APPLICATIONS

This application claims priority to U.S. Provisional Patent Application No. 62/205831, filed Aug. 17, 2015, and U.S. Provisional Patent Application No. 62/205815, filed Aug. 17, 2015. Both of said applications are incorporated by reference herein.

### TECHNICAL FIELD OF INVENTION

The present invention relates to hydroculture. One embodiment of the invention comprises a synthetic soil. Another embodiment of the invention comprises a method of growing plants in the synthetic soil.

### BACKGROUND OF INVENTION

Hydroculture refers to the growing of plants in a soil-less medium or an aquatic based environment, in which plant nutrients are distributed via water. Hydrophonics is a branch of hydroculture involving the growing of plants using mineral nutrient solutions, in water, without soil.

When attempting to grow plants without soil, the roots of the plants often need anchoring during growth. There is a need for a soil-less medium that can be used to anchor plant roots when grown in a soil-less environment.

### SUMMARY OF INVENTION

An object of the present invention is to provide a hydroculture media that can anchor the roots of plants being grown hydroponically. This and other objects of the invention can be achieved by embodiments of the invention disclosed below.

One embodiment of the present invention comprises a hydroculture media for anchoring plant roots in a hydroculture solution comprising a synthetic soil. The synthetic soil comprises a three dimensional solid comprised of a plurality of fibers, wherein the fibers are adapted to support the plant roots.

According to another embodiment of the invention, at least some of the plurality of fibers include an antimicrobial substance.

According to another embodiment of the invention, the antimicrobial substance comprises silver ions and/or copper ions.

According to another embodiment of the invention, at least some of the plurality of fibers include a plant nutrient.

According to another embodiment of the invention, the plurality of fibers comprise polyolefin, polyester, polyamide, and/or cellulosic.

According to another embodiment of the invention, the plurality of fibers comprise at least two different polymers.

According to another embodiment of the invention, the plurality of fibers comprise fibers having different deniers.

According to another embodiment of the invention,

According to another embodiment of the invention, the plurality of fibers comprise a first fiber having a first cross sectional shape, and a second fiber having a second cross sectional shape different than the first cross sectional shape.

According to another embodiment of the invention, at least some of the plurality of fibers have an adhesive surface.

According to another embodiment of the invention, the three dimensional solid has a shape selected from the group consisting of a sphere, cylinder, cone, cube, cuboid, parallelepiped, polyhedron, prism, spheroid, ellipsoid, paraboloid, hyperboloid, and ring.

According to another embodiment of the invention, the three-dimensional solid has a length/diameter ratio in the range of 0.1-5:1.

Another embodiment of the invention comprises a method of growing a plant without natural soil. The method includes providing a hydroculture medium comprising a three dimensional solid comprised of a plurality of fibers adapted to support plant roots, and placing a plant seed in the hydroculture medium.

According to another embodiment of the invention, the plant growing method includes placing the hydroculture medium with the plant seed in a hydroculture solution.

### BRIEF DESCRIPTION OF THE DRAWING

FIG. 1 is a perspective view of hydroculture media according to a preferred embodiment of the invention.

### DETAILED DESCRIPTION OF PREFERRED EMBODIMENTS OF INVENTION

A hydroculture media, according to a preferred embodiment of the invention, comprises a synthetic soil comprising a three dimensional solid comprised of a plurality of fibers. At least some of the fibers include antimicrobial substances and/or nutrients.

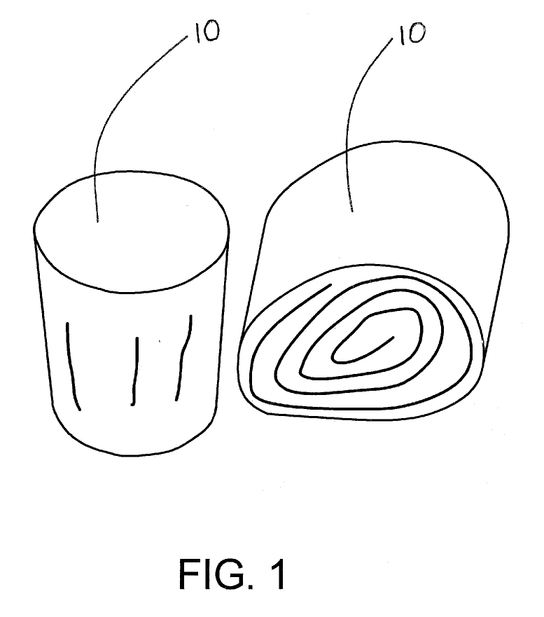

A three-dimensional solid, as used herein, refers to any three-dimensional solid. Preferably, the three-dimensional solids have a length/diameter (L/D) ratio in the range of 0.1-5:1. In another preferred embodiment, the L/D ratio is in the range of 1-3:1. In yet another embodiment, the L/D ratio is in the range of 1-2:1. Such three dimensional solids include, but are not limited to, spheres, cylinders, cones, cubes, cuboids, parallelepipeds, polyhedrons (e.g., pyramid, tetrahedron, octahedron, dodecahedron, icosahedron, etc.), prisms, spheroids, ellipsoids, paraboloids, hyperboloids, rings, and combinations thereof. The three dimensional solid excludes flat or planar solids, in which the L/D ratio is greater than 50:1. Such flat or planar solids can include sheets, films, membranes, webs, and may be made of solid material (e.g., extruded from molten polymer) or fibrous material (e.g., porous sheet, film, or membrane, or a fibrous web (nonwoven)). In a preferred embodiment of the invention, the synthetic soil comprises a substantially cylindrical solid, as shown at reference numeral 10 in FIG. 1.

The solid is comprised of a plurality of fibers. The fibers can be staple or filaments or a combination of both. The fibers can have a single length or the length of the fibers can vary. The fibers can have a single denier or the fibers can have varying deniers. The fiber can have any cross-sectional shape or a combination of different cross-sectional shapes. Such cross-sectional shapes include, but are not limited to, round, flat, trilobal, cruciform, octalobal (4DG), hollow, polygonal, oval, serrated, lima bean triangular lobular, mushroom, dog-bone ribbon-shaped, Y-shaped, star or concertina-shaped, and combinations thereof. The plurality of fibers can be made of a single polymer or the plurality of fibers can be a mixture of fibers made of differing polymers. Suitable polymers can be any fiber formable polymer, such as melt spinnable or solution spinnable. Such polymers include, but are not limited to, polyolefins, polyesters, polyamides, and cellulosics.

The plurality of fibers can include binder fibers. The binder fibers can be bicomponent fibers. The ratio of binder fibers to total fibers is preferably in the range of 5-40:100 (and any subset thereof). Bicomponent fibers can be, for example, sheath-core, side-by-side, or island-in-the-sea type bicomponent fibers, in which the first component of the fiber is a low polymer melt (in relation to the second polymer) and the second component is a high melt polymer (in relation to the first polymer).

In one embodiment of the invention, the fiber has an adhesive surface and an oil-absorbing particle is affixed to the adhesive surface. The adhesive surface can be a thermally active surface and/or a tacky surface.

The thermally active surface can be obtained by the use of a bicomponent fiber, in which the first component of the fiber is a low polymer melt in relation to the second polymer, and the second component is a high melt polymer in relation to the first polymer. Bicomponent fibers can be, for example, sheath-core, side-by-side, or island-in-the-sea type bicomponent fibers. When bicomponent fibers are used to adhere oil-absorbing particles, the ratio of bicomponent fibers to total fibers may increase 560:100, or 5-55:100, or 5-50:100, or 5-45:100 (and any subset thereof).

According to one embodiment of the invention, the tacky surface can be obtained by applying a plasticizer to the fiber or the surface of the fiber. For example, plasticizers, such as triacetin or TEGDA (triethylene glycol diacetate), can be used to plasticize the surface of a cellulosic, such as cellulose acetate.

In another embodiment of the invention, the tacky surface can be obtained by applying a tackifier to the fiber or the surface of the fiber. The tackifier can be any adhesive with good tack properties.

In yet another embodiment, the tacky surface can be obtained by a chemical agent applied to the fiber or the surface of the fiber. For example, polyamide (nylon) fiber can be treated with an acid solution.

According to a preferred embodiment of the invention, at least some of the fibers include antimicrobial substances and/or nutrients. The antimicrobial substances and/or nutrients can be incorporated into the fibers or affixed to the surface of the fibers. The antimicrobial substance can be any antimicrobial substance. The antimicrobial substance can be any substance used to inhibit the growth of microbial substances that would interfere with the growth of the plant. In one embodiment, the antimicrobial substances can be silver and/or copper ions. These ions can be incorporated into the fiber during the spinning process or affixed to the fibers surface, as described above.

The nutrients can comprise any nutrient. The nutrient can be any substance that facilitates the growth of the plant. Nutrient ions can be incorporated into the fiber during the spinning process or affixed to the fibers' surface, as described above. In one embodiment, the nutrient can be derived from sterilized cow manure, such as the sterilized cow manure in granulated form sold by OSM Environmental of Newark, N.Y.

In a method of using the synthetic soil according to a preferred embodiment of the invention, seeds can be place in the synthetic soil and then the seeded synthetic soil can be placed in a hydroculture solution. As the seeds sprout and grow, the roots use the fibers as a scaffold. That is, the roots are supported by the synthetic soil or branch out or spread out in the soil. By so doing, the entire root system can be bathed in the hydroculture solution. The denier of the fibers can be varied, to alter the pore size within the soil, which allows the soil to be tailored to different plant species. The amount (or concentration) of the antimicrobial substance and/or nutrient can also be varied to accommodate various plant species.

Hydroculture media and a method of using same are described above. Various changes can be made to the invention without departing from its scope. The above description of various embodiments and best mode of the invention are provided for the purpose of illustration only and not limitation—the invention being defined by the claims and equivalents thereof.

What is claimed is:

1. A hydroculture medium for anchoring plant roots in a hydroculture solution comprising a three dimensional solid comprised of a plurality of fibers, wherein the fibers are adapted to support the plant roots.

2. The hydroculture medium according to claim 1, wherein at least some of the plurality of fibers include an antimicrobial substance.

3. The hydroculture medium according to claim 2, wherein the antimicrobial substance comprises at least one selected from the group consisting of silver ions and copper ions.

4. The hydroculture medium according to claim 1, wherein at least some of the plurality of fibers include a plant nutrient.

5. The hydroculture medium according to claim 1, wherein the plurality of fibers comprise at least one polymer selected from the group consisting of polyolefin, polyester, polyamide, and cellulosic.

6. The hydroculture medium according to claim 1, wherein the plurality of fibers comprise at least two different polymers.

7. The hydroculture medium according to claim 1, wherein the plurality of fibers comprise a first fiber having a first different denier, and a second fiber having a second denier different than the first denier.

8. The hydroculture medium according to claim 1, wherein the plurality of fibers comprise a first fiber having a first cross sectional shape, and a second fiber having a second cross sectional shape different than the first cross sectional shape.

9. The hydroculture medium according to claim 1, wherein at least some of the plurality of fibers have an adhesive surface.

10. The hydroculture medium according to claim 1, wherein the three dimensional solid has a shape selected from the group consisting of a sphere, cylinder, cone, cube, cuboid, parallelepiped, polyhedron, prism, spheroid, ellipsoid, paraboloid, hyperboloid, and ring.

11. A method of growing a plant without natural soil, comprising the steps of:
(a) providing a hydroculture medium comprising a three dimensional solid comprising a plurality of fibers, the fibers adapted to support plant roots; and
(b) placing a plant seed in the hydroculture medium.

12. The method according to claim 11, further comprising the step of placing the hydroculture medium with the plant seed in a hydroculture solution.

13. The method according to claim 11, wherein at least some of the plurality of fibers include an antimicrobial substance.

14. The method according to claim 11, wherein at least some of the plurality of fibers include a plant nutrient.

15. The method according to claim 11, wherein the plurality of fibers comprise at least one polymer selected from the group consisting of polyolefin, polyester, polyamide, and cellulosic.

16. The method according to claim 11, wherein the plurality of fibers comprise at least two different polymers.

17. The method according to claim 11, wherein the plurality of fibers comprise at least two polymers selected from the group consisting of polyolefin, polyester, polyamide, and cellulosic.

18. The method according to claim 11, wherein the plurality of fibers comprise a first fiber having a first different denier, and a second fiber having a second denier different than the first denier.

19. The method according to claim 11, wherein the plurality of fibers comprise a first fiber having a first cross sectional shape, and a second fiber having a second cross sectional shape different than the first cross sectional shape.

20. The method according to claim 11, wherein the three-dimensional solid has a length/diameter ratio in the range of 0.1-5:1.
